(19) United States
(12) Patent Application Publication
(10) Pub. No.: US 2007/0008948 A1
(43) Pub. Date: Jan. 11, 2007

(54) Apparatus and method for providing subscriber information during wait time in a mobile communication system

(75) Inventors: Jun-Young Jung, Yongin-si (KR); Young-Soo Park, Yongin-si (KR); Joon-Young Choi, Suwon-si (KR); Geun-Ho Lee, Suwon-si (KR); Young-Ho Kim, Suwon-si (KR); Jae-Gwa Lee, Seoul (KR); Dong-Seek Park, Yongin-si (KR); Young-Kwon Cho, Suwon-si (KR); Jae-Hyuk Jang, Deagu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/482,935

(22) Filed: Jul. 10, 2006

(30) Foreign Application Priority Data
Jul. 8, 2005 (KR) 2005-61583

(51) Int. Cl. H04J 3/06

(52) U.S. Cl. 370/350

(57) ABSTRACT

An apparatus and method for providing subscriber information in a mobile communication system are provided. A database stores registered information containing subscriber information, a scope of persons to view the subscriber information, and an open level for the subscriber information. A wait time information management server stores the subscriber information in the database. Upon request for a call from a calling terminal, the wait time information management server searches for the subscriber information in the database and provides the searched subscriber information according to the open level to an MSC. The MSC sends wait time information based on the subscriber information received from the wait time information management server to the calling terminal.

### CROSS-REFERENCE TO RELATED PATENT APPLICATION

This application claims the benefit under 35 U.S.C. § 119(a) to a Korean Patent Application filed in the Korean Intellectual Property Office on Jul. 8, 2005 and assigned Serial No. 2005-61583, the entire disclosure of which is hereby incorporated by reference.

### BACKGROUND OF THE INVENTION

1. Field of the Invention

The present invention relates generally to a mobile communication system. More particularly, the present invention relates to an apparatus and method for providing information during call wait time.

2. Description of the Related Art

In a wired communication system interworking with a Public Switched Telephone Network (PSTN), when a communication channel is established by a communication protocol, a Mobile Switching Center (MSC) sends a ring tone to a person called and a dull ring-back tone to a caller. The ring-back tone and the ring tone are output through the speakers of the caller's phone and the called person's phone, respectively. Today, a variety of ring tones are available to a person called so that the phone's ringer can be customized according to taste.

As with the wired communication system, in a mobile communication system, at call termination, a preset music set on a terminal is played, whereas at call origination, a dull ring-back tone is output in the terminal, in compliance with a conventional ring-back tone standard.

Recently, a so-called coloring service has been provided, which is a music decoration service that lets the caller hear music or a message selected by the person called, instead of the conventional ring-back tone. There are two types of coloring services: One type of coloring service is to send a ring-back tone with a sound source preset by the person called and whereas the other type of coloring services is to send a ring-back tone with a sound source preset by the caller. These coloring services are mere sound source provisioning services in which a dull ring-back tone is replaced by music. In case of a video call-enabled terminal, a pre-shot advertisement is provided to the caller during wait time, but with limited information.

As described above, simple information such as a user-registered or user-requested sound source and an advertisement has limitations in attracting the caller's interest and is not useful to the caller. Once information is initially registered, only the information is provided. Therefore, it is impossible to update the information or provide new information in real time. Since the caller passively receives information set by the person called, information search, selective information reception, and active utilization of information are not viable for the caller.

Post-3rd Generation (3G) communication systems build an environment enabling more active data communications and provide diverse contents and multimedia data during call wait time. However, such a service is yet to be specified.

Accordingly, there is a need for an improved apparatus and method for providing subscriber information during a call wait time in a mobile communication system.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for providing various pieces of subscriber information during wait time in a mobile communication system.

Another aspect of exemplary embodiments of the present invention is to provide an apparatus and method for providing and utilizing subscriber information, such as, user profile of a person called in real time during call wait time in a mobile communication system.

A further aspect of exemplary embodiments of the present invention is to provide an apparatus and method for collecting caller-requested information and providing the collected information in real time to a caller during call wait time in a mobile communication system.

The above objects are achieved by providing an apparatus and method for providing subscriber information during wait time in a mobile communication system.

According to one aspect of exemplary embodiments of the present invention, in an apparatus for providing subscriber information in a mobile communication system, a database stores and manages registered information containing subscriber information of a subscriber to be provided to a calling terminal during wait time before a call connection to the subscriber, information about the scope of persons allowed to view the subscriber information, and information about an open level for the subscriber information. A wait time information management server receives the subscriber information from the subscriber and stores the subscriber information in the database. Upon request for a call from the calling terminal, the wait time information management server searches for the subscriber information in the database and provides the searched subscriber information according to the open level to an MSC. The MSC, upon request for the call from the calling terminal, requests the subscriber information to the wait time information management server and sends wait time information based on the subscriber information received from the wait time information management server to the calling terminal.

According to another aspect of exemplary embodiments of the present invention, in an apparatus for providing subscriber information in a mobile communication system, a database stores and manages registered information containing subscriber information of a subscriber to be provided to a calling terminal during wait time before a call connection to the subscriber, information about the scope of persons allowed to view the subscriber information, and information about an open level for the subscriber information. A wait time information management server receives the subscriber information from the subscriber and stores the subscriber information in the database. When interworking with a media server is necessary, the wait time information management server requests the subscriber information to the media server, receives the subscriber information from the media server, and sends the subscriber information according to the open level to an MSC. The media server searches for the requested subscriber information and sends the searched subscriber information to the wait time information management server. The MSC, upon request for a call from the calling terminal, requests the subscriber information to the wait time information management server and sends wait time information based on the subscriber information received from the wait time information management server to the calling terminal.

According to a further aspect of exemplary embodiments the present invention, in a method of providing subscriber information in a mobile communication system, subscriber information of a subscriber and information about an open level for the subscriber information are received over a wired or wireless network and stored in a database. Wait time information is generated based on the subscriber information according to the open level, upon request for a call from a calling terminal. The wait time information is sent to the calling terminal.

According to still another aspect of exemplary embodiments the present invention, in a method of providing subscriber information in a wait time information management server in a mobile communication system including an MSC requesting subscriber information of the subscriber to the wait time information management server, upon request for a call to a subscriber from a mobile communication terminal, and sending wait time information based on the subscriber information received from the wait time information management server to the mobile communication terminal, and the mobile communication terminal for reproducing the wait time information received from the MSC during wait time for a call connection to the subscriber, the subscriber information and information about an open level of the subscriber information received from the subscriber are stored in a database. Upon request for the call from the mobile communication terminal, the subscriber information is searched for in the database and provided to the MSC according to the open level.

According to yet another aspect of exemplary embodiments the present invention, in a method of providing subscriber information in a mobile communication system, subscriber information and information about an open level of the subscriber information are received over a wired or wireless network and stored in a database by a wait time information management server. Upon request for a call from a calling terminal, the subscriber information is requested to the wait time information management server by an MSC. The subscriber information is sent to the MSC according to the open level by the wait time information management server. Wait time information is generated based on the subscriber information and sent to the calling terminal, and the call is requested to the subscriber by the MSC. The wait time information is reproduced during wait time for the call connection by the calling terminal.

According to an aspect of exemplary embodiment of the present invention, there is provided a computer readable medium storing a computer readable program for a method of providing subscriber information in a mobile communication system, subscriber information of a subscriber and information about an open level for the subscriber information are received over a wired or wireless network and stored in a database. Wait time information is generated based on the subscriber information according to the open level, upon request for a call from a calling terminal. The wait time information is sent to the calling terminal.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 conceptually illustrates the configuration of a mobile communication system according to an exemplary embodiment of the present invention;

FIG. 2 is a diagram illustrating a signal flow for providing subscriber information during call wait time in the mobile communication system according to an exemplary embodiment of the present invention;

FIG. 3 is a diagram illustrating a signal flow for providing subscriber information during call wait time in the mobile communication system according to an exemplary embodiment of the present invention;

FIG. 4 is a diagram illustrating a signal flow for providing subscriber information during call wait time in the mobile communication system according to an exemplary embodiment of the present invention;

FIG. 5 is a flowchart illustrating an operation for providing subscriber information during call wait time in the mobile communication system according to an exemplary embodiment of the present invention; and

FIG. 6 illustrates an example of wait time information provided to a calling terminal in the mobile communication system according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

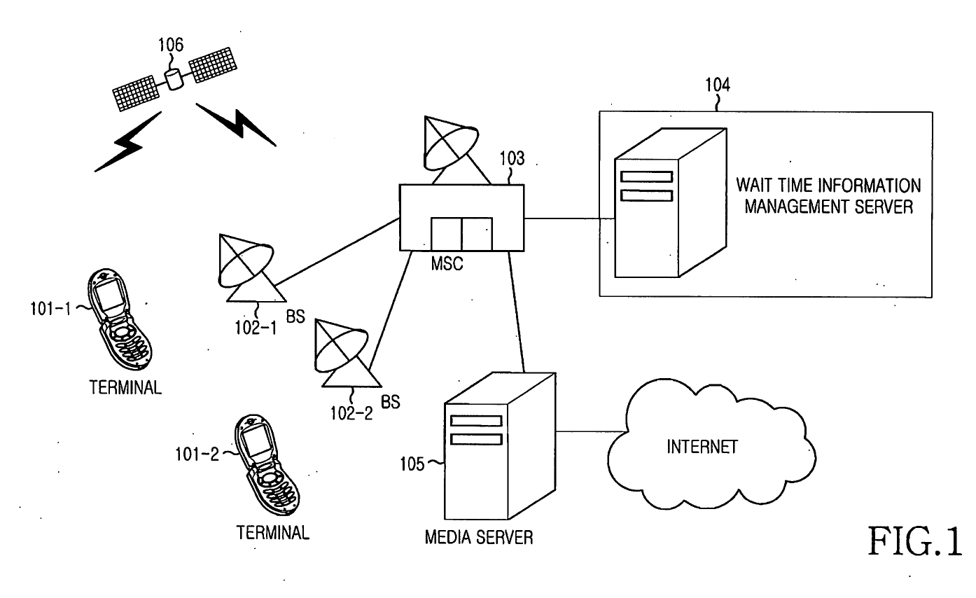

FIG. 1 conceptually illustrates the configuration of a mobile communication system according to an exemplary embodiment of the present invention.

Referring to FIG. 1, terminals 101-1 and 101-2 are wireless subscribers' terminals each moving within a service area and communicate with base stations (BSs) 102-1 and 102-2 on radio channels. The terminals are classified into three types of terminals: a stationary or slow terminal, Personal Station (PS); a fast terminal, Mobile Station (MS) as in a vehicle or an aircraft; and a satellite-based terminal, Mobile Earth Station (MES).

The BSs 102-1 and 102-2 transfer signals received on radio channels from the terminals 101-1 and 101-2 within their service areas to an MSC 103. Reversely, the BSs 102-1 and 102-2 transfer signals received from the MSC 103 to the terminals 101-1 and 101-2 on the radio channels.

The MSC 103 interfaces between the PSTN and a mobile communication network. It provides a circuit-switched service to subscribers, searches for all data required for call processing in the databases of a Home Location Register (HLR, not shown) and a Visitor Location Register (VLR), and updates the databases with the latest data. In addition to typical functionalities, the MSC 103 receives subscriber information preset by a subscriber from a predetermined server, generates wait time information using the received subscriber information, and sends the wait time information to a calling terminal according to an exemplary embodiment of the present invention.

A media server 105 stores multimedia contents files including music, movies, music videos, and the like. In addition to the typical functionalities, upon request, the media server 105 searches a database for contents associated with a called subscriber registered to a wait time information management server and sends the contents to the wait time information management server according to an exemplary embodiment of the present invention. The media server 105 interworks with a Web server in order to interface between a subscriber terminal and the Web via a wireless data communication network. In accordance with an exemplary embodiment of the present invention, when a caller requests a call connection to a person called, the caller may request a Web page associated with the person called or a search for information about the person called to the Web server via the media server 105 and receive the requested information during wait time.

A wait time information management system 104 includes the wait time information management server, for registering/managing information about subscribers and providing a wait time information service to the subscribers. In accordance with an exemplary embodiment of the present invention, the wait time information management system 104 may further include a location information registration/management server (not shown) for registering and managing the location information of called terminals.

The location information registration/management server tracks the location of a subscriber using a Location Based Service (LBS) system and provides the location information in real time. There are two LBS schemes: a cell-based LBS through a BS and a Global Positioning System (GPS)-based LBS through a satellite navigator.

In the cell-based LBS service, a subscriber registers his location to a serving cell. A BS or Access Point (AP) having the subscriber within its coverage periodically reports the location information to an HLR of the MSC that manages the BS or AP. Then the HLR stores and manages the location information. The HLR also controls calls for the subscriber or additional services such as incoming/outgoing call restriction. For example, upon request for an LBS service, the HLR provides the registered location information under its management according to an exemplary embodiment of the present invention. In case of an AP-based LBS service, location tracking is relatively accurate because the service radius of an AP is smaller than the service radius of a conventional cell.

The GPS-based LBS service tracks the locations of the terminals 101-1 and 101-2 with the aid of a GPS satellite 106 and thus provides location information of the terminals 101-1 and 101-2 in real time. The location information of a called terminal equipped with a GPS receiver is sent by communications with the called terminal. In accordance with an exemplary embodiment of the present invention, the location information registration/management server registers and manages the location information of the called terminal using the cell-based or GPS-based LBS system in the wait time information management system 104.

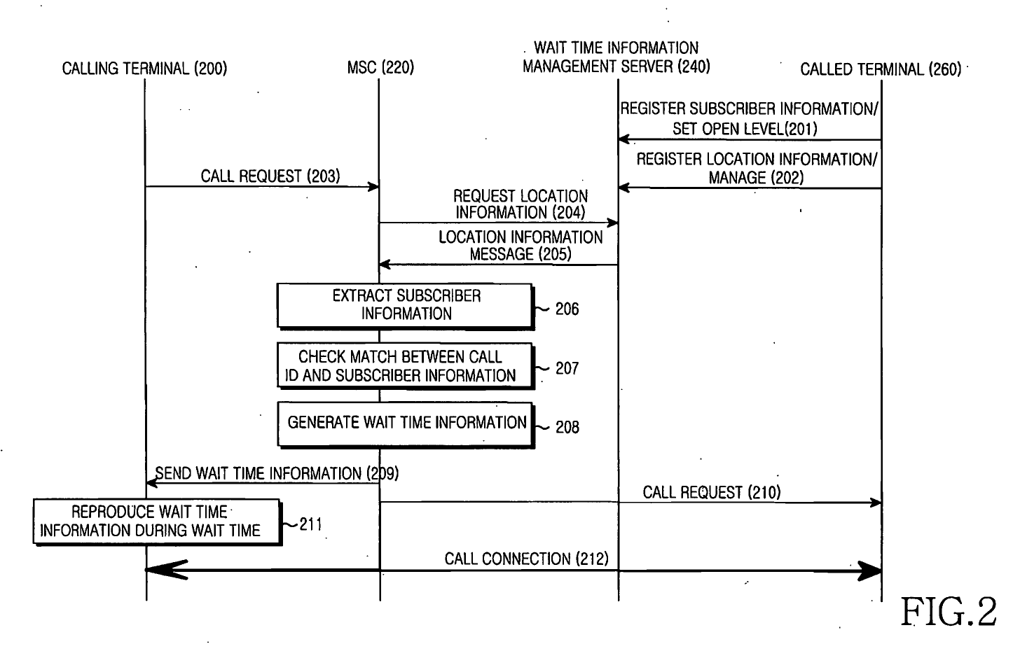

FIG. 2 is a diagram illustrating a signal flow for providing subscriber information during wait time in the mobile communication system according to an exemplary embodiment of the present invention.

Referring to FIG. 2, a called terminal 260 subscribes to a wait time information service by registering its subscriber information to a wait time information management server 240 and sets an open level for the subscriber information in step 201. The subscriber information is a voice message, an image, a moving picture, and the like set by the called terminal. Upon request for a call from a calling terminal, the subscriber information is provided to the calling terminal.

In accordance with an exemplary embodiment of the present invention, a subscriber can generate his subscriber information on his mobile terminal or the Web. For example, the subscriber accesses the Web and uploads a user profile including a photo, personal information, a greeting message, and the like, in a predetermined template provided by a service provider, thereby easily creating various contents. The subscriber then registers the user profile to a communication service provider or the wait time information management system. Upon request for a call from a calling terminal, the registered wait time information is provided to the calling terminal during wait time for a call connection. Considering the wait time for a call is usually less than one minute, the wait time information, for example, contains as much information as viewable during the wait time. The wait time information may be provided to the subscriber in a predetermined template.

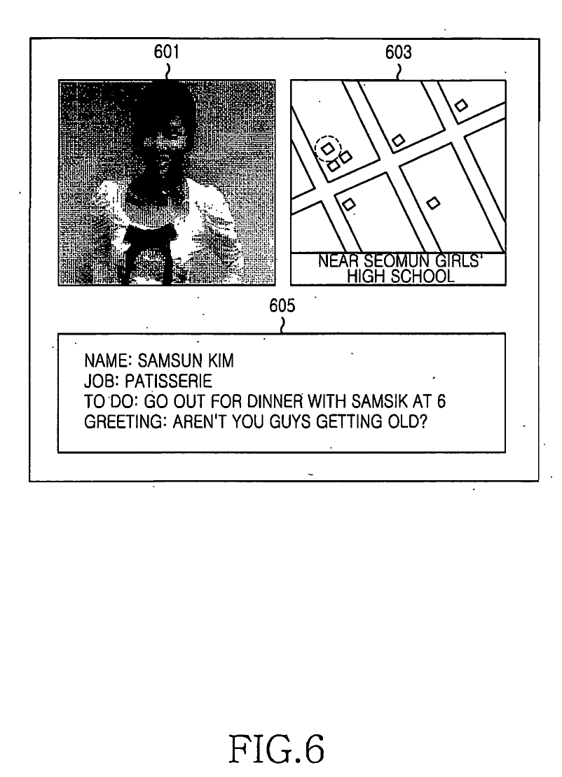

FIG. 6 illustrates an example of wait time information provided to a calling terminal in the mobile communication system according to an exemplary embodiment of the present invention.

Referring to FIG. 6, a subscriber preliminarily registers her photo 601 and her subscriber profile 605 with a simple greeting message. When a caller places a call, the registered information 601 and 605 are displayed together with real-time location information 603 of the called subscriber on an idle-mode screen of the caller.

An open level for the subscriber information is set for privacy protection. With the open level, the subscriber may decide whether the subscriber information is to be open and how much of the subscriber information is viewable. The subscriber can prevent indiscriminate disclosure of his subscriber information by setting the open level during registering the subscriber information. For privacy protection, the subscriber information is preferably viewable by persons that the subscriber designates. For example, the subscriber registers persons listed in its directory as allowed to view the subscriber information. Thus, the open level setting prevents indiscriminate disclosure or theft of the location and personal information of the subscriber.

In step 202, the called terminal 260 registers its location information to the wait time information management server 240. When a calling terminal 200 sends a call request message to a MSC 220 in step 203, the MSC 220 verifies that the called terminal 260 has subscribed to the wait time service and sends a location information request message to the wait time information management server 240 in step 204. The wait time information management server 240 searches the database for the location information of the called terminal 260 and sends a location information message to the MSC 220 according to the preset open level in step 205.

The MSC 220 extracts the subscriber information from the location information message in step 206 and determines whether the subscriber information matches with a call IDentifier (ID) in step 207. If the subscriber information and a call ID match, the MSC 220 generates wait time information in step 208. The wait time information contains the location information received from the wait time information management server 240, and subscriber information set in the form of voice, images, and moving pictures by the called terminal 260 during the service subscription.

After generating the wait time information, the MSC 220 sends the wait time information to the calling terminal 200 in step 209 and requests a call to the called terminal 260 in step 210. The calling terminal 200 views the received wait time information during wait time before the call connection, thus finding out the location of the called terminal 260 in step 211. When the call connection is established between the calling terminal 200 and the called terminal 260, the calling terminal 200 discontinues the data reproduction and starts to converse with the called terminal 260 in step 212. In an exemplary implementation, the wait time information is provided for a predetermined time even after the call connection.

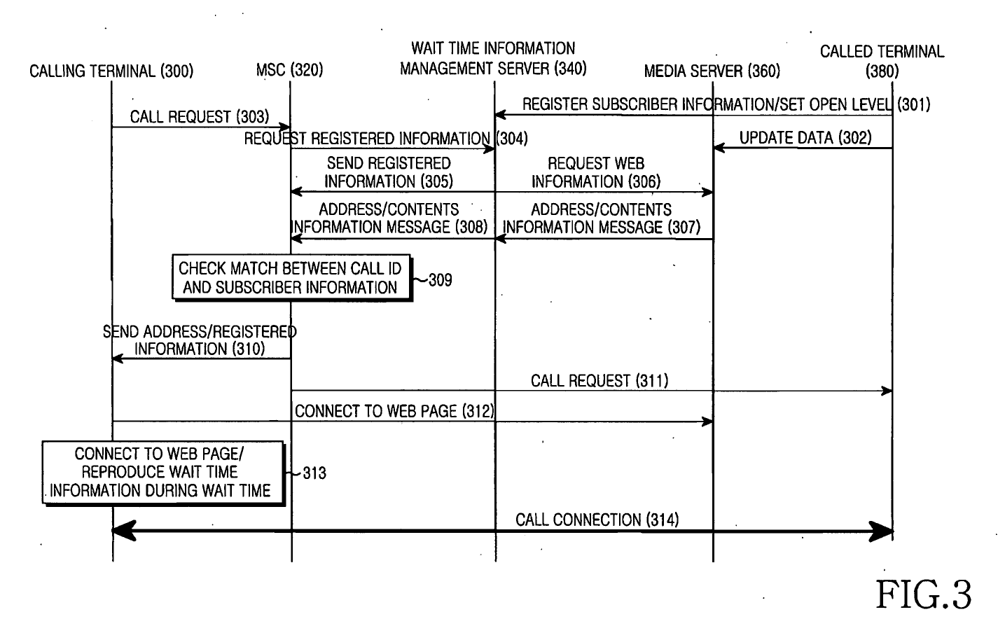

FIG. 3 is a diagram illustrating a signal flow for providing subscriber information during wait time in the mobile communication system according to an exemplary embodiment of the present invention.

Referring to FIG. 3, a called terminal 380 subscribes to a wait time information service by registering its subscriber information to a wait time information management server 340, and sets an open level for the subscriber information in step 301. The subscriber information may contain a photo, personal information, a to-do-list, and Web link information. According to an exemplary embodiment of the present invention, the subscriber can manage a personal Web page such as a mini home page or a blog and provide a Web address to a calling terminal during call wait time so that the caller can access the mini home page or the blog by wireless Internet. During the wait time, the wireless communication network may directly provide contents on the Web page to the calling terminal. In step 302, the called terminal 380 accesses a media server 360, and manages and updates the personal information on the personal Web page.

When a calling terminal 300 sends a call request message to a MSC 320 in step 303, the MSC 320 sends a registered information request message to the wait time information management server 340 in step 304. The wait time information management server 340 verifies that the called terminal 380 has subscribed to the wait time information service, searches for the registered subscriber information of the called terminal 380 and sends the subscriber information to the MSC 320 according to the preset open level in step 305. In step 306, the wait time information management server 340 sends a Web information request message to the media server 360 using the registered Web link information, for example, an IP address or a Web address, in step 306.

The media server 360 sends the personal Web address of the called terminal 380 and a content information message to the MSC 320 via the wait time information management server 340 in steps 307 and 308. The MSC 320 compares the user information with a call ID in step 309. If the user information and call ID match, the MSC 320 creates wait time information based on the registered subscriber information and the Web address/content information received from the wait time information management server 340 and sends the wait time information to the calling terminal 300 in step 310. The wait time information may contain a photo, self-introduction, a to-do-list, and a Web address like a blog and a home page received from the wait time information management server 340 and the media server 360. In step 311, the MSC 320 sends a call request message to the called terminal 380.

Upon key input from the user, the calling terminal 300 can access the Web page of the person called using the received Web address in step 312. For example, during the wait time before a call connection to the called terminal 380, the caller can access the Web page of the person called and receive information about the person called in real time. Also, the calling terminal 300 may reproduce the registered subscriber information received from the wait time information management server 340 during the wait time in step 313. When the call is connected to the called terminal 380, the calling terminal 300 starts to converse with the called terminal 380, discontinuing any provisioning of the wait time information in step 314. If the call is not connected, the Web connection may continue unless the caller enters an End key. In an exemplary implementation, the wait time information is provided for a predetermined time even after the call connection.

The information of the person called on the Web displayed on the caller's idle-mode screen is from an introductory page of a mini-home page or a home page of a Web site managed by the person called. Therefore, the information is complied suitably for the communication environment and User Interface (UI) of the calling terminal.

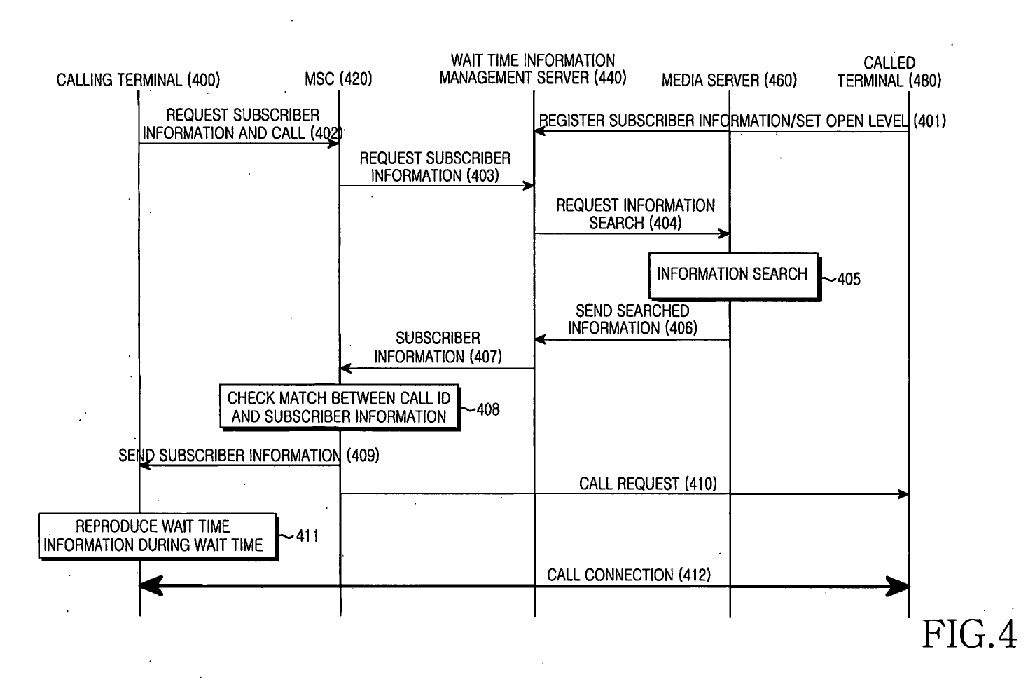

FIG. 4 is a diagram illustrating a signal flow for providing subscriber information during wait time in the mobile communication system according to an exemplary embodiment of the present invention.

Referring to FIG. 4, a called terminal 480 subscribes to a wait time information service by registering the subscriber information of a called subscriber to a wait time information management server 440 and sets the open level of the subscriber information in step 401. In accordance with an exemplary embodiment of the present invention, the person called may preset various pieces of subscriber information including bio rhythm, stock quotes, hobbies, specialties, human relation information, and personal information so that a caller can search for his intended information about the person called. For example, the caller may find out the bio rhythm of the person called before a call connection and thus conduct a more active conversation after a call connection based on the bio rhythm. A telemarketer searches for the human relation information or personal information of a person called before a call connection to utilize the information in telemarketing.

In step 402, a calling terminal 400 sends a call request message with a code value indicating an intended information type to be searched for to a MSC 420. The information is real-time information accessible on the Web, such as the bio rhythm, hobbies, specialties, human relation information, and personal information of the person called. Information types to be searched for are mapped to predetermined code values as illustrated in Table 1. When requesting a call, the caller requests a search for particular information by sending a corresponding code value. For example, to find out the bio rhythm of the person called during wait time, the caller requests a search for the bio rhythm information by entering a code value corresponding to the bio rhythm information, a called number, and a Send key, for example, “*2*+01099998888+Send key”.

TABLE 1

| Code | Requested Information | LINK |
|---|---|---|
| 01 | Persons | http://www.donga.com/inmul/ |
| | | inmul_search.html |
| 02 | Bio Rhythm | http://www.sazu.net |
| 03 | Stock Quotes | 211.156.43.121 |
| 04 | Weather | Weather forecast from Korea |
| | | meteorological administration |
| 05 | Movies | http://www.movie.com |
| 06 | Food | http://www.Food.co.kr |
| 07 | Travel | http://www.LotteTour.com |

The above code values are preset between the system and subscribers, representing information types that the caller may request about the person called.

Upon receipt of the call request message with a code value, the MSC 420 requests a search for the information indicated by the code value to the wait time information management server 440, determining that the calling terminal 400 wants to search for the information during the wait time, in step 403. The wait time information management server 440 verifies that the called terminal 480 has subscribed to the wait time service and detects the information type that the caller wants to search for based on the code value in the information search request message. Then the wait time information management server 440 sends an information search request message to a media server 460 so that the media server 460 searches for the information according to the preset open level for the subscriber information in step 404.

The media server 460 searches for the information from a database or a Web site in step 405 and sends the searched information to the wait time information management server 440 in step 406. The media server 460 may search for the information in real time and provide the searched information in the form of an instant message for utilization by the caller. The information is generated personally for human relation management and stored in a user database or on the Web by the person called. For example, the information may be about a company, human relations, schedule, bio rhythm, or personal information. When a person is called, the caller may request an information search by setting a code value representing an intended information type.

Then the wait time information management server 440 sends the subscriber information to the MSC 420 in step 407. The MSC 420 compares the user information with a call ID in step 408. If the user information and call ID match, the MSC 420 sends the subscriber information to the calling terminal 400 in step 409. In step 410, the MSC 420 pages the person called by sending a call request message to the called terminal 480.

In step 411, the calling terminal 400 reproduces the subscriber information received from the MSC 420 during wait time. When the call is connected to the called terminal 480, the calling terminal 400 communicates with the called terminal 480, discontinuing the data reproduction in step 412. In an exemplary implementation, the wait time information is provided for a predetermined time even after the call connection.

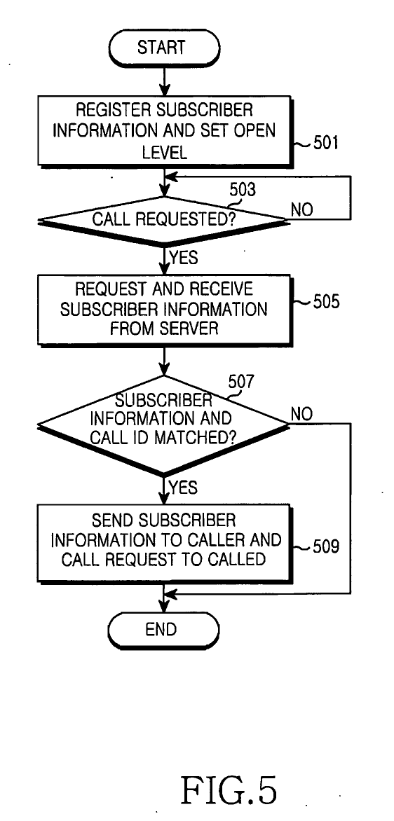

FIG. 5 is a flowchart illustrating an operation for providing subscriber information during wait time in the mobile communication system according to an exemplary embodiment of the present invention.

Referring to FIG. 5, the mobile communication system registers information about a subscriber to the wait time information management server 104 and sets an open level for the subscriber information as requested by the subscriber in step 501. The subscriber information to be provided during wait time can be location information, personal information on the Web, and caller-requested searched information associated with the subscriber. The personal information on the Web may be a photo, a blog, a home page, self-introduction, schedule, and the like. The searched information may be information about a company, human relations, schedule, bio rhythm, and personal details. The caller can request a search for subscriber information by sending a call request message containing a search code assigned to the subscriber information. The search code is preset between the system and the subscriber.

The MSC 103 monitors reception of the call request message from the calling terminal in step 503. Upon receipt of the call request message, the MSC 103 verifies that the called terminal has subscribed to the wait time service and requests the subscriber information to the wait time information management server 104 to which the person called has already registered the subscriber information in step 505. The wait time information management server 104 may access the media server 105, search for the requested information according to the open level, and send the searched information to the MSC 103.

In step 507, the MSC 103 determines whether the received subscriber information matches with a call ID. If the received subscriber information and call ID match, the MSC 103 generates wait time information using the received subscriber information and sends the wait time information to the calling terminal, while sending a call request message to the called terminal in step 509. The calling terminal may reproduce the received wait time information during wait time before a call connection. The algorithm then ends.

It can be further contemplated that the mobile communication system supporting the wait time information service provides subscriber information containing the location information/Web data/searched data of the person called in a combination of the exemplary embodiments of the present invention.

FIG. 6 illustrates an example of wait time information provided to a calling terminal in the mobile communication system according to an exemplary embodiment of the present invention. Referring to FIG. 6, the wait time information is information set and registered by a subscriber. The wait time information characteristically contains real-time location information. Since various pieces of wait time information is utilizable during wait time before a call connection, the wait time information is preferably implemented a flash page or a Web page.

As described above, the exemplary embodiments of the present invention provides basic information and other information about a person called during wait time in a mobile communication system, thereby offering a tool that eliminates time during the wait time. The wait time information service could be a new terminal/system profit model and is applicable to business, particularly customer and human relation management. Also, useful and highly processed information tailored to meet a user's needs is provided during a short wait time for a call connection through multi-function integration. The wait time information service can serve other purposes than a call connection. For example, when a call is unavailable to a person called, a caller may determine whether to call again by finding out the status of the person called.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for providing subscriber information in a mobile communication system, the apparatus comprising:
a database for storing and managing registered information containing subscriber information of a subscriber to be provided to a calling terminal during wait time before a call connection to the subscriber, information regarding a scope of persons allowed to view the subscriber information, and information regarding an open level for the subscriber information; and
a wait time information management server for receiving the subscriber information from the subscriber, storing the subscriber information in the database, and upon request for a call from the calling terminal, searching for the subscriber information in the database and providing the searched subscriber information according to the open level to a mobile switching center (MSC),
wherein the MSC generates wait time information based on the subscriber information received from the wait time information management server, upon request for the call from the calling terminal, requests the subscriber information to the wait time information management server, and sends the wait time information to the calling terminal.

2. The apparatus of claim 1, wherein the wait time information includes at least one of a subscriber profile set by the subscriber, subscriber information provided by a communication service provider, a flash, a personalized Web page of the subscriber, a Web address of the subscriber, and the current location of the subscriber.

3. The apparatus of claim 2, wherein the wait time information management server comprises a location information registration/management server for tracking the location of the subscriber and providing the location information of the subscriber.

4. An apparatus for providing subscriber information in a mobile communication system, comprising:
a database for storing and managing registered information containing subscriber information of a subscriber to be provided to a calling terminal during wait time before a call connection to the subscriber, information regarding a scope of persons allowed to view the subscriber information, and information regarding an open level for the subscriber information; and
a wait time information management server for receiving the subscriber information from the subscriber, storing the subscriber information in a database, and when interworking with a media server is necessary, requesting the subscriber information to the media server, receiving the subscriber information from the media server, and sending the subscriber information according to the open level to a mobile switching center (SC),
wherein the media server searches for the requested subscriber information and sends the searched subscriber information to the wait time information management server, and
the MSC generates wait time information based on the subscriber information received from the wait time information management server, upon request for a call from the calling terminal, requests the subscriber information to the wait time information management server, and sends the wait time information to the calling terminal.

5. The apparatus of claim 4, wherein the wait time information includes at least one of a subscriber profile set by the subscriber, subscriber information provided by a communication service provider, a flash, a personalized Web page of the subscriber, a Web address of the subscriber, and the current location of the subscriber.

6. The apparatus of claim 5, wherein the calling terminal at least one of reproduces the wait time information received from the MSC and accesses a Web site associated with the subscriber using the Web address during the wait time.

7. The apparatus of claim 5, wherein the calling terminal sends a call request message with a code value representing information to be searched for the MSC, receives the wait time information from the MSC, and reproduces the wait time information during the wait time, the wait time information being generated based on the searched information.

8. A method of providing subscriber information in a mobile communication system, comprising:
receiving subscriber information of a subscriber and information regarding an open level for the subscriber information over at least one of a wired or wireless network and storing the received subscriber information and the open level information in a database;
generating wait time information based on the subscriber information according to the open level, upon request for a call from a calling terminal; and
sending the wait time information to the calling terminal.

9. The method of claim 8, wherein the wait time information includes at least one of a subscriber profile set by the subscriber, subscriber information provided by a communication service provider, a flash, a personalized Web page of the subscriber, a Web address of the subscriber, and the current location of the subscriber.

10. The method of claim 8, further comprising, generating the wait time information based on the subscriber information received from a server, when interworking with the server is required to acquire the subscriber information.

11. The method of claim 10, wherein the server is a media server.

12. The method of claim 10, wherein the calling terminal requests the call by a message including a code value representing information to be searched for.

13. A method of providing subscriber information in a wait time information management server in a mobile communication system including a mobile switching center (MSC) for generating sending wait time information based on subscriber information received from the wait time information management server, upon request for a call to a subscriber from a mobile communication terminal, requesting subscriber information of the subscriber to the wait time information management server, and sending the wait time information to the mobile communication terminal, and the mobile communication terminal for reproducing the wait time information received from the MSC during wait time for a call connection to the subscriber, the method comprising:
storing the subscriber information and information regarding an open level of the subscriber information received from the subscriber in a database; and
searching the subscriber information in the database, upon request for the call from the mobile communication terminal, and providing the subscriber information to the MSC according to the open level.

14. The method of claim 13, further comprising:
requesting the subscriber information to a server, when interworking with the server is required for acquiring the subscriber information; and
sending the subscriber information received from the server to the MSC.

15. A method of providing subscriber information in a mobile communication system, comprising the steps of:
receiving subscriber information and information regarding an open level of the subscriber information received over at least one of a wired or wireless network and storing the subscriber information and the open level information in a database by a wait time information management server;
requesting the subscriber information to the wait time information management server by a mobile switching center (MSC), upon request for a call from a calling terminal;
sending the subscriber information to the MSC according to the open level by the wait time information management server;
generating wait time information based on the subscriber information, sending the wait time information to the calling terminal, and requesting the call to the subscriber by the MSC; and
reproducing the wait time information during wait time for the call connection by the calling terminal.

16. The method of claim 15, further comprising:
requesting the subscriber information to another server by the wait time information management server; and
sending the subscriber information received from the server to the MSC by the wait time information management server.

17. A computer readable medium storing a computer readable program for a method of providing subscriber information in a mobile communication system, the method comprising:
receiving subscriber information of a subscriber and information regarding an open level for the subscriber information over at least one of a wired or wireless network and storing the received subscriber information and the open level information in a database;
generating wait time information based on the subscriber information according to the open level, upon request for a call from a calling terminal; and
sending the wait time information to the calling terminal.

18. The computer readable medium of claim 17, wherein the wait time information includes at least one of a subscriber profile set by the subscriber, subscriber information provided by a communication service provider, a flash, a personalized Web page of the subscriber, a Web address of the subscriber, and the current location of the subscriber.

19. The computer readable medium of claim 17, further comprising, generating the wait time information based on the subscriber information received from a server, when interworking with the server is required to acquire the subscriber information.

20. The computer readable medium of claim 19, wherein the server is a media server.

21. The computer readable medium of claim 19, wherein the calling terminal requests the call by a message including a code value representing information to be searched for.

22. An apparatus for providing subscriber information in a mobile communication system, the apparatus comprising:
a database for storing and managing registered information containing subscriber information of a subscriber to be provided to a calling terminal during wait time before a call connection to the subscriber; and
a wait time information management server for receiving the subscriber information from the subscriber, storing the subscriber information in the database, and upon request for a call from the calling terminal, searching for the subscriber information in the database and providing the searched subscriber information.

23. An apparatus for providing subscriber information in a mobile communication system, comprising:
a database for storing and managing registered information containing subscriber information of a subscriber to be provided to a calling terminal during wait time before a call connection to the subscriber; and
a wait time information management server for receiving the subscriber information from the subscriber, storing the subscriber information in a database, and when interworking with a media server is necessary, requesting the subscriber information to the media server, receiving the subscriber information from the media server, and sending the subscriber information,
wherein the media server searches for the requested subscriber information and sends the searched subscriber information to the wait time information management server.
